(19) United States
(12) Patent Application Publication
(10) Pub. No.: US 2003/0175670 A1
(43) Pub. Date: Sep. 18, 2003

(54) Patient-oriented medical services learning and information program

(76) Inventor: Ronald A. Raddon, Draper, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/099,761

(22) Filed: Mar. 15, 2002

(51) Int. Cl. G09B 23/28; G09B 25/00; G09B 3/00

(52) U.S. Cl. 434/262; 434/365; 434/350

(57) ABSTRACT

The present invention features a system for educating individuals about a particular health care service or procedure, and particularly to a patient-oriented medical procedure educational program comprising one or more learning tools in a viewable media, wherein the learning tool comprises informational content thereon that pertains to one or more specific health-related issues associated with a medical procedure to be provided to a patient. The informational content itself comprises procedure-specific information and ancillary information associated with the procedure-specific information and the medical procedure itself. The program also comprises means for administering or providing the learning tool to an individual. The program is designed to be sold directly to patients or physicians, or the program may be implemented through a participating provider service offered through an insurance company.

### BACKGROUND

1. Field of the Invention

The field of the invention relates to educational learning and information programs, and particularly to a pre-operative, post-operative, and procedure-related video learning and information program and a method of conducting business for such a program, wherein the program is designed to educate and inform prospective patients and/or their families about the operating procedure being undertaken, as well as ancillary information related to the operating procedure, such as what to expect before and after the procedure, how to prepare for the procedure, and other related information that may be beneficial to the patient.

2. Background of the Invention and Related Art

Medical technology and medical procedures have evolved significantly over the past several decades. Indeed, many new and exciting surgical procedures, treatments and cures, preventative medicines, and other discoveries have made the modern age of medicine the most advanced in history. These advances are not only evident in the most complex of health related problems and conditions, but also in those relatively simple.

Despite these advances and the ability of medical professionals to alleviate many health related problems, visits to these medical professionals and the hospitals and clinics in which these people work can be an extremely daunting and intimidating experience for most individuals. This is especially true when one is required to be present due to some health problem or condition that requires surgery or some other invasive type of procedure.

Perhaps some of the biggest reasons that visits to various medical professionals and hospitals or clinics is so daunting and such a negative experience is the lack of knowledge a person has about his or her condition, the fear associated with that condition, a complete unawareness of the types of treatments or procedures that will be required to alleviate the particular problem, and/or what the individual may do or not do to improve his or her existing condition, etc. Lack of knowledge and fear present two potent ingredients for a very negative and unpleasant experience, which is often the case surrounding the treatment of a particular medical condition. Stated differently, an individual who is in need of surgery due to some unforeseen event or perhaps due to some condition that has perpetuated and worsened over time, or an individual who is required to undergo one treatment or several repeat treatments for a particular condition (e.g. chemotherapy for cancer patients, etc.), or even patients undergoing elective surgery, will often lack a suitable knowledge and understanding about the particular condition, the potential treatment procedures, and what to expect both during and after the treatment or surgery. For example, a patient who visits a doctor and finds out that he/she is in need of immediate surgery for an existing condition may be overwhelmed and frightened by the news and even more so by the thought of having to undergo surgery with little or no warning. This may cause extreme anxiety in both the patient and the patient's family, especially if the patient leaves the doctor retaining little or no information regarding the particulars of the procedure or treatment.

This type of fear and anxiety that is often associated with adverse medical conditions such as those described above, is rarely subdued by the medical professionals or other personnel to the satisfaction of the patient or their families. Ideally, a patient would be able to sit down with his or her doctor, a nurse, or some other type of medical personnel who is knowledgeable about the adverse condition and the procedure that will be used to treat or alleviate the condition, who would then explain to them the condition, the procedure, etc., as well as field or answer any questions posed by the patient and his/her family. For example, one undergoing surgery may have several unanswered questions and a very limited knowledge about both pre-operative and post-operative situations. However, in today's fast-paced and insurance-influenced medical world, such a thorough and personal informative visit is rarely possible. As such, patients undergo life changing medical care experiences with little or no knowledge about what is actually being done to them and how to care for themselves both before and after the care is performed.

On a more specific level, there are many things an individual may want to be informed about that pertain to, or that are either directly or indirectly related to the particular medical condition or situation of the patient. For example, in the case of one undergoing surgery, there may be specific things the patient should be aware of or perhaps would want to know prior to undergoing the actual procedure. Such pre-operative information may include a brief but detailed explanation of the adverse medical condition of the patient, the surgical procedure that will be performed, how the patient can prepare for the surgery, what types of things to expect, how long the surgery will last, potential risks involved and their probabilities, what to expect from the surgery as far as success rates, etc., and any other type of information related to the pre-operative period that may be useful or beneficial to the patient and their family.

On the other hand, there may be several specific things the patient should be aware of, or perhaps would want to know following the surgical procedure. Such post-operative information may include how to care for the patient after the surgery, potential side effects, general information on types of pain or discomfort often experienced, what types of things can assist and speed recovery, what medications to take and correct dosages, any physical therapy that may be helpful, potential problems that may arise and how to spot these, activities to avoid, and any other type of information related to the post-operative period that may be beneficial to the patient and their family.

Such information would also be desirable for those who are not necessarily undergoing surgery or various other involved medical procedures, but who are undergoing less involved or intrusive medical treatments, or even physical therapy, home health care, etc.

As stated above, insurance companies play a major role in the management and administration of provided medical/health care. These insurance companies often work closely with physicians, hospitals, and other health care providers and entities to ensure they are adequately providing quality and efficient health care. There are certain things a health care professional is responsible for overseeing. One of these is providing informative care. Often a patient will initiate a medical malpractice suit against a doctor or nurse because they were not adequately informed of certain facts or made aware of certain risks, etc. As such, insurance premiums are extremely high for health care professionals. Therefore, any way to decrease these costs and to improve productivity would be well accepted.

### SUMMARY AND OBJECTS OF THE INVENTION

Based on the foregoing, there remains a need for a system and/or method of educating those in need of medical attention, such as patients undergoing surgery, etc., and instructing them from both a pre-operative and a post-operative standpoint.

Therefore, it is an object of some embodiments of the present invention to provide a method of doing business to implement a patient-oriented informative learning program into the field of health care.

It is another object of some embodiments of the present invention to provide a patient-oriented system and learning program for educating and instructing patient's about various health care conditions and health-related services, as well as ancillary information pertaining to these.

It is still another object of some embodiments of the present invention to provide a patient-oriented system and learning program designed to disseminate information about both pre-operative and post-operative phases of health care.

It is a further object of some embodiments of the present invention to provide a method and system for supplementing the medical professional's or health care facility's patient instruction regarding the patient's particular medical condition and need, as well as the health care practices intended for treatment.

It is still a further object of some embodiments of the present invention to provide a patient-oriented system and learning program to help health care professionals increase productivity and to better manage their time.

It is still a further object of some embodiments of the present invention to provide a patient-oriented system and learning program to help health care professionals cut insurance and malpractice costs, as well as to reduce the number of overall claims filed.

In accordance with the invention as embodied and broadly described herein, the present invention features a system for educating individuals about a particular health care service or procedure, and particularly to a patient-oriented medical service educational program comprising one or more learning tools in a viewable media, wherein the learning tool comprises informational content thereon that pertains to one or more specific health-related issues associated with a medical service to be provided to a patient. The informational content itself comprises service or procedure-specific information and ancillary information associated with the service or procedure-specific information and the medical procedure itself. The program also comprises means for administering or providing the learning tool to an individual.

In a preferred embodiment, the patient-oriented program comprises informational content that focuses on pre-procedure/service information, instruction, and preparation, as well as post-procedure/service information and instruction. For example, one undergoing surgery may have the benefit of the patient-oriented program to become educated not only on the actual surgical procedure itself, but on several ancillary issues that are either directly or indirectly associated with the particular surgical procedure and related health care services.

Prior to surgery, one may be given a pre-procedure/service or pre-operative video explaining the surgical procedure in detail, what to expect from the surgery, how to prepare for the surgery, the potential risks involved, and any other noteworthy topic or issue that may be relevant and related to the surgical procedure that the patient would want to know. This video may be watched by the patient, any family or friends of the patient, and any other individual wishing to learn about the surgical procedure.

Following the surgery, the patient may be provided a post-procedure/service or post-operative video explaining the issues relevant to the post-operative phase. These issues or topics may include such things as a brief summary of what has been done, an explanation of how the surgery might affect the patient, potential problems to be aware of and to look for, suggested ways to improve and speed recovery, types of medications that may be available, instructions on acceptable nutrition and physical exertion, activities to avoid, and any other noteworthy information that may be relevant that the patient or the family of the patient would want to know.

One or more of the program learning tools may also be viewed by the family in the waiting room of the hospital or other care facility during performance of the actual procedure or service.

While the above preferred embodiment discusses the patient-oriented program in terms of a surgical procedure, the patient-oriented program is designed to be tailored to any type of medical or health care service or procedure. There are countless topics or issues that would be beneficial to individuals facing adverse health condition and that are in need of some type of medical assistance, albeit invasive or non-invasive. In addition, there are many types of other health care services that would benefit from the program of the present invention, such as cosmetic or homeopathic health care services.

One of the primary purposes of the patient-oriented medical service program, other than to educate various individuals about a particular health care service, is to allow health care professionals, such as physicians, nurses, etc., to have access to the program in order to provide redundant disclosure to reduce some of their responsibility to educate and discuss the service being provided. As this material may be taken home and viewed in a relaxed environment, more information will be retained by the patient. As such, the patient-oriented program is designed to supplement whatever information a health care professional offers the person receiving the health care attention, and may be used to reiterate the information presented by the health care professional and the information actually absorbed by the patient or the patient's family and friends. Indeed, several factors may play a role as to why health care professionals do not spend adequate time educating the patient on the particular service being offered. Such factors may include a limited amount of available time for doing such, pressure from managed health care facilities to push through patients, lack of discipline by the health care professional to do so, etc.

In addition, through the use of the program, health care professionals are able to reduce costs, more effectively manage their time, increase productivity, reduce the overall amount of malpractice claims filed against them, reduce insurance premium costs, etc. These are only some of the recognized advantages. Others will be obvious to one ordinarily skilled in the art.

The patient-oriented medical services program, and particularly the learning tool, preferably comprises one or more viewable media capable of storing and disseminating the contained informational content in video form accompanied by audio. The media may also be in a format designed to educate individuals with disabilities, such as blindness or deafness. The media may also be in different languages to allow more patient's to view the information in a relaxed atmosphere where retention and understanding are increased.

The present invention further features a method of conducting business to provide a method of instructing an individual, and particularly a patient, about a specific health care service or procedure. Specifically, the present invention features a method for conducting the above-described patient-oriented medical service educational program comprising the steps of gathering service-specific information related to one or more medical services; gathering ancillary information related to the service-specific information; fixing the service-specific information as well as the ancillary information in a learning tool comprising a viewable media comprising health-related content; and supplying the learning tool to a target subject to create a patient-oriented medical service educational program. The target subject may be a patient, to whom the learning tool is offered directly, either independently or through coordination with a medical professional, such as the patient's doctor. The target may be a physician, to whom the learning tool is offered directly; or the target may be a health care provider, such as a hospital, or a managed health care facility, such as an HMO, or an insurance company, wherein the learning tool and the program is offered to an individual, such as a patient, through a contracted arrangement or agreement with one or more of these entities. Such should help to increase productivity of the health care professional, as well as to reduce claims filed against the professional and to overall costs, such as reducing malpractice and other insurance premiums.

The method of conducting business to provide a patient-oriented medical services educational program may further comprise affiliating with various businesses wishing to promote their products through advertising within the program.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates, generally, the method of providing the patient-oriented medical services educational program to a patient through various means.

### DETAILED DESCRIPTION OF THE PREFERRED EMBODIMENTS

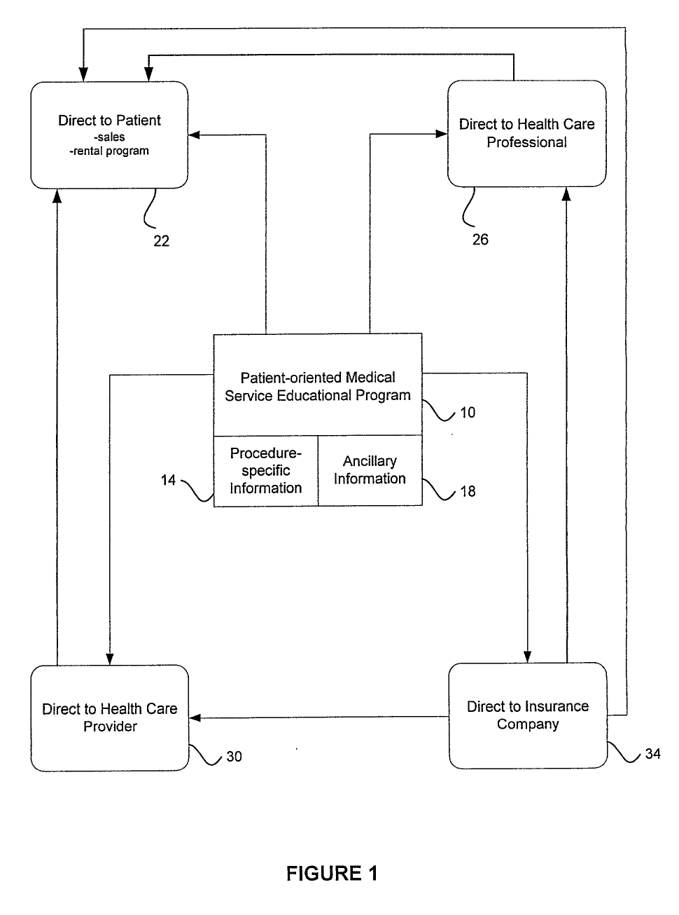

It will be readily understood that the components of the present invention, as generally described and illustrated in the figures herein, could be arranged and designed in a wide variety of different configurations. Thus, the following more detailed description of the embodiments of the system and method of the present invention as represented in FIGS. 1 through *, is not intended to limit the scope of the invention, as claimed, but is merely representative of the presently preferred embodiments of the invention.

The present invention describes a method and system for teaching and educating an individual about a health related service, such as a medical procedure, through a patient-oriented medical services educational program. The present invention applies to both the actual educational or learning tools or media containing the information and the content thereon, as well as the business method or structure for providing such tools to the target audience. As such, the following more detailed description is organized into two major sections corresponding to the aforementioned primary aspects of the present invention. The first section discusses the learning tool and the program itself with respect to the informational content contained thereon. The second section discusses the methods and structure designed to provide and implement the program.

### Patient-Oriented Medical Services Educational Program

As discussed above, it is not uncommon for an individual in need of medical care to receive that care with little or no instruction or education regarding the particular service or procedure being performed. The typical amount of education one receives is either from direct contact with the health care professional, such as the patient's doctor, in an effort to explain the service or procedure, or through the self-taught efforts of the individual to research and learn about the service or procedure. In most cases, such efforts are marginal with results being limited and incomplete, which can lead to great misunderstanding and even anxiety in one in need of medical attention. The lack of knowledge about an issue so personal and delicate as a medical service or procedure can be very disconcerting to most people. However, constraints put on health care professionals often do not afford them the opportunity to take sufficient time with a patient and their family or friends to answer questions or explain in any great detail the many issues surrounding a service being offered or a procedure being performed. Moreover, from a health care professional's standpoint, it is very time consuming and difficult to answer questions and explain in detail to each and every patient being seen the issues surrounding the service or procedure. However, not doing so opens up the door for adverse action or claims to be filed against the health care professional. This in turn may cause an increase in insurance premiums as the potential for suit is increased.

In light of the foregoing, the present invention seeks to provide a system and method for overcoming the shortfalls of prior systems and methods by providing a patient-oriented medical service (e.g. performance of a medical procedure) educational program.

The program is designed to educate an individual about any conceivable type of health related or medical service, the most common being medical procedures that are to be performed on a patient, such as a surgical procedure, or various treatments that are needed, such as chemotherapy, etc. However, these are not meant to limit the program of the present invention as other types of health related information may be provided through the program. For example, one may wish to learn about various cosmetic services that are available to treat or correct a particular problem; or one may desire to know alternative approaches that may be available, such as any homeopathic or acupuncture remedies; or one may wish to familiarize themselves about home health care. The content potential is endless. What is advantageous about the program of the present invention no matter what type of information is being conveyed is that it provides a tool that may be used by health care professionals to educate patients and their families at the level of detail that would normally be impossible in a live, personal setting. Therefore, the patient-oriented program is designed to include many content specifics, and is not to be limited to those specifically described herein.

The patient-oriented program of the present invention comprises one or more learning tools contained in or comprising a viewable media. The viewable media has thereon the informational content selected to be provided or conveyed to the receiving individual. This information is selected by either the health care professional, the health care facility, the insurance company, or a combination of these. The learning tool comprises informational content pertaining to one or more specific health-related issues that are associated with a medical service, wherein medical service is defined broadly to cover any conceivable topic of information as discussed above (e.g. procedures, treatments, etc.). The informational content comprises both service/procedure specific information, as well as ancillary information associated with the particular medical service being offered.

Service-specific information, and particularly procedure-specific information, may be any relevant or pertinent information that deals directly with the specifics of the procedure or treatment, etc. that is being offered to the individual by a health care professional or facility. Procedure-specific information may include information such as the length of the procedure, the details on what the procedure entails, the risks involved, if any, how the procedure will be performed, and a detailed step by step explanation of the procedure if necessary. For example, if an individual were going to have an appendix removed, the service-specific information would most likely focus on the symptoms associated with an inflamed appendix, the location of incision, how the surgery is performed, the length of time it takes to remove the appendix, and any other relevant information that would be useful to the patient. The extent of the service-specific content is dependent upon several factors, such as the type of service to be rendered, etc. Therefore, the discussion herein is merely intended to provide an example or a guideline of the types of information that may be provided. One ordinarily skilled in the art will recognize the several possible issues and topics to be covered by the service-specific information.

Ancillary information comprises that which would be beneficial to the patient or individual to know, both prior to and after the medical service, and that is somehow associated or related to the service-specific information. Ancillary information comprises any information contained in the program that is not service-specific. For instance, an individual would benefit from knowing how to prepare for a particular service, such as a surgical procedure, or may even desire to know what types of things are allowed and what types of things are restricted following the service. As such, ancillary information is best described as comprising pre-service information and post-service information. Ancillary information may also include advertising or other similar information.

Pre-service information is defined as information pertaining to a particular medical service (as defined above) that should be known by and that would be beneficial to an individual or patient prior to the rendering or performance of the medical service. For purposes of illustration, the term pre-operative will be used to describe the type of pre-service information that is available through the program of the present invention pertaining to a surgical procedure. Other types of pre-service information, such as pre-treatment information (dealing with medical services involving treatments instead of procedures), is intended to fall within the scope of protection of the program of the present invention and should be recognized as such.

Pre-operative information is any information that an individual should know or would want to know going into a surgical procedure. Pre-operative information may deal with, either directly or indirectly, service-specific information or ancillary information. The most common topics or issues of pre-operative information will focus on educating the individual about the procedure itself as discussed above, informing the individual of any potential risks that may be involved with undergoing the surgery, explaining how the individual should prepare for the surgery in terms of nutrition, diet, physical exertion, mental preparations, etc., what to expect from performing the surgery, any alternatives that may be available to the patient, and any other information that may be relevant to the particular surgical procedure.

Post-service information is defined as information pertaining to a particular medical service (as defined above) that should be known by and that would be beneficial to an individual or patient following the rendering or performance of the medical service. For purposes of illustration, the term post-operative will be used to describe the type of post-service information that is available through the program of the present invention pertaining to a surgical procedure. Other types of post-service information, such as post-treatment information (dealing with medical services involving treatments instead of procedures), is intended to fall within the scope of protection of the program of the present invention and should be recognized as such. One of the advantages of the program of the present invention is that this pre-operative information may be received by the individual or patient in a non-stressful environment, such as in the comfort of their own home, rather than at the health care facility where such information is typically conveyed out of convenience.

Post-operative information is any information that an individual or patient would want to know following the surgical procedure. The most common topics or issues of post-operative information will focus on what to expect from the surgery, any potential problems that may arise and what to do in case they appear, any symptoms that the patient can expect, proper nutrition and diet practices that should be followed and for how long, when the patient may begin to be active, recovery tips and procedures, such as physical therapy practices, etc., any medication that may be available and how to administer such medication, and any other type of information that is deemed relevant. Another advantage to the program of the present invention is that such post-operative information may be conveyed when the patient is fully coherent and able to comprehend and process such information. Typically, one undergoing surgery is told what they can expect and what to do just prior to leaving the hospital. Under these circumstances, the patient may be under the influence of medication, or may be likely still feeling the effects of the surgery. The conveyance of information at such a time may be easily forgotten or ignored altogether, thus putting the patient at risk. Moreover, the health care professional also puts him/herself at risk as ignored or forgotten information that is vital to the recovery to the patient may contribute to potential malpractice claims.

Other advantages are also recognized by the patient-oriented program of the present invention. First, health care professionals are able to improve time management because they do not have to take valuable individual time to explain the actual procedure or what it involves, nor do they have take time to answer questions about the same as the each of these will most likely be covered by the program as described herein. Of course, the program is intended not to replace the health care professional's responsibility to inform and discuss the particular matter with the patient, rather the program is intended to supplement or compliment this process. Any remaining questions or concerns not covered in the program should be addressed by the health care professional after the program is viewed by the patient and/or the family of the patient.

Second, the patient-oriented program may help health care professionals to increase revenue. This is related to time management in that by offering the program to patients, less time will be spent in conveying valuable information about the procedure, which equates to shorter and more numerous patient visits.

Third, the patient-oriented program will help health care professionals reduce insurance costs. By implementing the program of the present invention, insurance companies will be able to be assured that vital information is being conveyed to the patient about the particular procedure being undertaken. By arming the patient with knowledge that is critical to be conveyed, less ammunition for a malpractice claim is taken from the patient. This amounts to less frequent malpractice suits and ultimately results in cheaper malpractice premiums required by the health care professional.

Still other advantages that are not expressly stated herein, but are within the intended scope of the present invention, may be recognized by one ordinarily skilled in the art. As such, those expressly recited herein are not to be considered limiting in any way.

The patient-oriented program further comprises means for administering the learning tool to an individual, such as the patient or the patient's family or friends, wherein the patient-oriented program is defined. Referring to FIG. 1, preferably, means for administering the patient-oriented medical services educational program 10 (via a learning tool), comprising procedure-specific information 14 and ancillary information 18, comprises providing the learning tool to the patient 22 through one of several ways. First, the learning tool may be supplied directly to the patient 22 through a purchase or rental agreement. Second, the learning tool may be provided directly to a health care professional 26, such as a physician, which would then offer the program to his/her patients for viewing. Third, the learning tool may be offered to a health care provider or facility 30, such as a hospital or managed health care facility (e.g. HMO), which would in turn set up a program with all attending health care professionals to ensure they provide the patient-oriented program to all patients under their care and care of the facility. Fourth, the learning tool may be provided to the patient through an insurance company 34. Each of these is discussed in greater detail below under the method of conducting business section.

The learning tool of the patient-oriented medical services program preferably comprises one or more viewable media capable of storing and disseminating the contained informational content in video form accompanied by audio. The preferred media are video tapes, CD-ROM's, DVD's, and/or various computerized digital formats capable of storing the and conveying the program information contained thereon, such as streaming or downloadable video through a global network such as the Internet, wherein a selectable menu is provided containing the one or more viewable patient-oriented programs. Moreover, the viewable media may be accompanied by various written materials to supplement the programs.

### Method of Conducting Business to Implement a Patient-Oriented Medical Services Educational Program

The program of the present invention may be implemented several ways. The specific methods covered herein are preferred, but are not meant to limit the present invention in any way.

The patient-oriented medical services educational program of the present invention is designed to ultimately educate and inform patients, family members and friends of the patient, etc., of the particular service being rendered to the patient by a medical professional or care facility. However, providing access to this program may be accomplished in several ways.

As briefly discussed above, the patient-oriented program may be offered or provided directly to the patients or family members themselves. The program may be advertised and marketed in various ways to reach different individuals who are in need of or who foresee the need for one or more medical services. The program may be offered and sold directly to the patient. Optionally, the program may be offered in a type of rental program with an associated rental agreement. This would allow an individual to view the program without having to purchase the program. In addition, this would allow a patient to view multiple programs if desired at a lower expense. This is especially convenient for elective medical procedures or treatments.

In another embodiment, the patient-oriented program may be provided directly to medical professionals. In this embodiment, physicians and other medical care professionals may use the program to supplement and compliment their patient visits with the information contained in the program. The patient-oriented program serves many purposes, one of which is to offer peace of mind to medical care professionals that any vital information about a particular service being rendered is being conveyed to the patient and/or their family, both prior to and after the performance of the service. For example, a doctor may provide a patient in need of heart surgery a program video covering all of the pre-service or pre-operative questions and concerns that that individual may have related to the heart surgery procedure. This program video would compliment or supplement any discussion the physician had directly with the patient in his/her visit. Following the surgery, the physician may provide the patient with a copy of a program video covering the post-service or post-operative information as defined and discussed above. Relatives may view the program in the hospital waiting room to prepare for returning the patient to their home.

In yet another embodiment, the patient-oriented program may be provided to a health care facility, such as a hospital or managed health care facility. In this embodiment, the care facility would offer the program to its medical staff on a request basis. Thus, a physician treating an individual may desire to provide the program video to the patient for their review and may do so under whatever agreement is in place between the care facility and the medical professionals. The hospital personnel may be trained, either on-site or at another location, on how to implement and use the patient-oriented program of the present invention.

Finally, in still a further embodiment, the patient-oriented program may be offered through a participating provider program. Under a participating provider program, an Insurance company offers to pay for the program to be introduced to a health care facility and/or a medical professional. Under this situation, the insurance company would offer to lower the costs of insurance premiums currently paid by the care facility and the medical care professionals under the condition that the patient-oriented program be implemented by the care facility or physician, such that the patients under their care would be offered the opportunity to view the patient-oriented program to become educated about the service being sought. In this embodiment the insurance company would be responsible for seeing that the care facilities and the medical care professionals under their care are properly instructed, through some type of training regimen, about the benefits of the patient-oriented program, the costs, the advantages, etc., and that the program is satisfactorily implemented. This may be done for each care facility and/or medical care professional affiliated with the insurance company and desiring to lower their insurance expenses.

Once the program in implemented and in effect, the care facility and the medical professionals would be responsible for actually carrying out the program and providing the program to the patients and their family members to be eligible for a reduction in insurance premiums.

The advantage to the care facilities and the medical professionals is that they serve to fulfill the daunting task of educating each patient and providing an in-depth look into the service being rendered. Indeed, doctors and nurses alike become so overwhelmed and pinched for time, that they neglect to offer to the patient more than a few minutes on what to expect from the service, etc., or to answer any questions that may arise. Moreover, whatever information is offered is often brief and unsatisfactory to the patient. However, as mentioned above, the constrains imposed upon medical professionals often do not provide them the opportunity to do more. As a result, many patients undergo medical procedures or services without having any idea as to what is being done, why, and what may be expected from the outcome.

By working with insurance companies to implement the patient-oriented program of the present invention, participating health care facilities and medical professionals are able to confidently inform their patients about any type of service needed or wanted, and in turn lower their insurance costs. In addition, the insurance company benefits because less valid and potentially litigious claims are filed due to the improved care and services offered to the patient.

It should be noted that any of the above-mentioned embodiments may be set up in an offer-sale arrangement, or they may utilize some type of rental system where one may view any of the program videos in the program library.

One unique arrangement made possible through the patient-oriented program of the present invention is the ability for various merchants and vendors to advertise their products on the program learning tool. Thus, various agreements may be made that allow these vendors and merchants to advertise their products on a program dealing or related to the products or services offered by the merchants. Such an arrangement would help to reduce the costs of manufacturing, producing, and in general, making the program, as well as distributing and marketing the program. For example, a video about a surgical procedure involving attachment of a prosthetic may include a short advertising segment about a company offering products and/or services in that area that may be beneficial to the patient. The fee for allowing such an advertisement may be negotiated.

The present invention further features a method for educating an individual on a specific medical service to be provided. The method specifically comprises the steps of: offering the individual a patient-oriented medical service educational program to complement and/or supplement any information provided to the individual by a medical professional regarding a needed or perceived medical service, wherein the program itself comprises one or more learning tools in a viewable media. The learning tool may comprise pre-procedure/service information, post-procedure/service information, and ancillary information associated with the pre-procedure/service and post-procedure/service information.

The present invention still further features a method for implementing a patient-oriented medical service educational program comprising the steps of obtaining a patient-oriented medical service educational program from a program provider; and supplementing live instructions and information to an individual, from a medical professional, by supplying the individual with the patient-oriented medical service educational program.

The present invention may be embodied in other specific forms without departing from its spirit of essential characteristics. The described embodiments are to be considered in all respects only al illustrative and not restrictive. The scope of the invention is, therefore, indicated by the appended claims, rather than by the foregoing description. All changes which come within the meaning and range of equivalency of the claims are to be embraced within their scope

What is claimed and desired to be secured by Letters Patent is:

1. A patient-oriented medical service educational program designed to educate an individual about a particular medical procedure, said program comprising:
a learning tool for viewing by a patient comprising viewable media containing informational content thereon, said informational content pertaining to one or more specific health-related issues associated with said medical service to be provided to a patient, said informational content comprising:
procedure-specific information, including symptoms, details on what said procedure involves, and how said procedure is performed;
ancillary information, including side-effects, pain levels, and appropriate activity levels, associated with said medical procedure; and
means for administering said learning tool to said individual.

2. The patient-oriented learning program of claim 1, further comprising one or more written materials intended to accompany said learning tool, said written materials comprising information pertaining to said medical procedure and said ancillary information.

3. The patient-oriented learning program of claim 1, wherein said informational content focuses on pre-procedure/service information, instruction, and preparation.

4. The patient-oriented learning program of claim 1, wherein said informational content focuses on post-procedure/service information and instruction.

5. The patient-oriented learning program of claim 1, wherein said informational content is contained on a viewable media comprising a video-cassette.

6. The patient-oriented learning program of claim 1, wherein said informational content is contained on a viewable media comprising a CD-ROM or DVD.

7. The patient-oriented learning program of claim 1, wherein said informational content is contained on a viewable media comprising a computerized digital format.

8. The patient-oriented learning program of claim 1, further comprising a library of said one or more viewable media, each of said media containing a different topic.

9. The patient-oriented learning program of claim 1, wherein said means for administering said learning tool comprises supplying said learning tool directly to a patient.

10. The patient-oriented learning program of claim 1, wherein said means for administering said learning tool comprises supplying said learning tool directly to a health care professional.

11. The patient-oriented learning program of claim 1, wherein said means for administering said learning tool comprises contracting with a health care provider to offer said patient-oriented medical procedure educational program to one or more patients in need of said medical procedures.

12. The patient-oriented learning program of claim 1, wherein said means for administering said learning tool comprises contracting with an insurance company to offer said patient-oriented medical procedure educational program, through a health care provider, to one or more patients in need of said medical procedures.

13. The patient-oriented learning program of claim 1, wherein said learning tool further comprises advertising material thereon related to said informational content.

14. The patient-oriented learning program of claim 13, wherein said advertising material facilitates said means for administering said program in that said means for administering further comprises contracting with one or more businesses to advertise on said learning tool in order to reduce manufacturing and operating costs.

15. A method for conducting a patient-oriented medical procedure educational program comprising the steps of:
gathering procedure-specific information related to one or more medical procedures;
gathering ancillary information related to said procedure-specific information;
fixing said procedure-specific information and said ancillary information in a learning tool comprising a viewable medial, said learning tool comprising health-related content; and
supplying said patient-oriented medical procedure educational program to a target subject to create a patient-oriented medical procedure educational program.

16. The method of claim 15, wherein said step of supplying comprises contracting with various health care providers to offer said learning tool to one or more patients in need of said medical procedures.

17. The method of claim 15, wherein said step of supplying comprises contracting with various insurance companies to offer said learning tool to one or more patients in need of said medical procedures.

18. The method of claim 15, wherein said step of supplying comprises providing said learning tool directly to a patient.

19. The method of claim 15, wherein said step of supplying comprises providing said learning tool directly to a physician.

20. The method of claim 15, wherein said procedure-specific information comprises audio and video data pertaining to a particular medical procedure/service.

21. The method of claim 15, wherein said ancillary information comprises pre-procedure/service information.

22. The method of claim 15, wherein said ancillary information comprises post-procedure/service information.

23. The method of claim 15, wherein said ancillary information comprises advertising information.

24. The method of claim 15, further comprising the step of updating said patient-oriented medical procedure educational program as needed.

25. The method of claim 15, further comprising the step of securing advertising slots, wherein advertising segments may be incorporated into said health-related content.

26. A method for implementing a patient-oriented medical procedure educational program comprising the steps of:
obtaining a patient-oriented medical procedure educational program from a program provider; and
supplementing live instructions and information to an individual, from a medical professional, by supplying said individual with said patient-oriented medical procedure educational program.

27. The method of claim 26, wherein said patient-oriented medical procedure educational program comprises:
a learning tool for viewing by a patient comprising one or more viewable media containing informational content thereon relating to said medical procedure, said informational content pertaining to one or more specific health-related issues corresponding to a medical procedure to be provided to a patient, said informational content comprising:
procedure-specific information;
ancillary information, including typical side effects, pain levels, and appropriate activity levels, associated with said medical procedure; and
means for administering said learning tool to said individual.

28. The method of claim 26, wherein said individual is a patient in need of specific medical attention.

29. The method of claim 26, wherein said individual is an acquaintance of a patient.

30. The method of claim 26, wherein said step of obtaining said patient-oriented medical procedure educational program comprises purchasing said program.

31. The method of claim 26, wherein said step of obtaining said patient-oriented medical procedure educational program comprises renting said program, wherein said program is returned by said individual.

32. A method for educating an individual on a specific medical procedure to be provided said individual, said method comprising the steps of:
offering said individual a patient-oriented medical procedure educational program to complement and supplement any information provided said individual by a medical professional regarding said medical procedure, said program comprising one or more learning tools in a viewable media, said learning tool comprising pre-procedure/service information, post-procedure/service information, and ancillary information associated with said medical procedure.

33. A learning tool designed to educate an individual about a particular medical procedure, said learning tool comprising:
at least one comprising viewable media for viewing by a patient, said viewable media containing informational content thereon, said informational content pertaining to one or more specific health-related issues associated with said medical procedure to be provided to a patient, said informational content comprising:
procedure-specific information; and
ancillary information, including side-effects, pain levels, and appropriate activity levels, associated with said medical procedure.

34. A patient-oriented medical procedure educational program designed to educate an individual about a particular medical procedure, said program comprising:
a learning tool comprising one or more viewable media containing informational content thereon, said informational content pertaining to one or more specific health-related issues corresponding to a medical procedure to be provided to a patient, said informational content comprising:
procedure/service-specific information; and means for administering said learning tool to said individual.

35. A patient-oriented medical procedure educational program designed to educate an individual about a particular medical procedure, said program comprising:
a learning tool comprising one or more viewable media containing informational content thereon, said informational content pertaining to one or more specific health-related issues corresponding to a medical procedure to be provided to a patient, said informational content comprising:
ancillary information pertaining to said medical procedure; and means for administering said learning tool to said individual.
